(19) United States
(12) Patent Application Publication
(10) Pub. No.: US 2025/0159779 A1
(43) Pub. Date: May 15, 2025

(54) LIGHTING MANAGEMENT APPARATUS, LIGHTING MANAGEMENT SYSTEM, LIGHTING MANAGEMENT METHOD, AND STORAGE MEDIUM

(71) Applicant: NEC Corporation, Minato-ku, Tokyo (JP)

(72) Inventors: Yuta NAMIKI, Tokyo (JP); Jianquan Liu, Tokyo (JP); Satoshi Yamazaki, Tokyo (JP); Noboru Yoshida, Tokyo (JP); Ryo Kawai, Tokyo (JP); Tingting Dong, Tokyo (JP); Karen Stephen, Tokyo (JP); Naoki Shindou, Tokyo (JP); Youhei Sasaki, Tokyo (JP)

(73) Assignee: NEC Corporation, MInato-ku, Tokyo (JP)

(21) Appl. No.: 18/832,157

(22) PCT Filed: Mar. 3, 2022
(86) PCT No.: PCT/JP2022/009201

§ 371 Date: Jul. 23, 2024

(51) Int. Cl. H05B 47/125; G06T 7/73; G06V 40/10; H05B 47/16; H05B 47/175

(52) U.S. Cl. CPC H05B 47/125; G06T 7/75; G06V 40/103; H05B 47/16; H05B 47/175; G06T 2207/30196

(57) ABSTRACT

A lighting management apparatus (101) includes a first acquisition unit (111), and a signal generation unit (112). The first acquisition unit (111) acquires analysis information based on a result being estimated by using an analysis of an image being acquired by photographing a target area TA. The analysis information includes a pose of a person P present in the target area TA. The signal generation unit (112) generates a control signal for controlling one or a plurality of pieces of lighting equipment LE being associated with the target area TA, by using the analysis information and a usage purpose of the target area TA.

### TECHNICAL FIELD

The present invention relates to a lighting management apparatus, a lighting management system, a lighting management method, and a storage medium.

### BACKGROUND ART

Patent Document 1 discloses a lighting control apparatus that controls a plurality of pieces of lighting equipment being arranged in a control target area in a distributed manner. The lighting control apparatus described in Patent Document 1 includes a first acquisition unit, a first control unit, a second acquisition unit, and a second control unit.

The first acquisition unit described in Patent Document 1 acquires positional information relating to a human in the control target area, together with identification information relating to mobile equipment carried by the human. The first control unit described in Patent Document 1 determines lighting equipment associated with a position at which a human stays in the control target area, based on the positional information, associates the lighting equipment being determined with identification information, and controls the lighting equipment being determined to a first state.

The second acquisition unit described in Patent Document 1 acquires an operation signal being associated with an operation with respect to the mobile equipment, together with the identification information. The second control unit described in Patent Document 1 controls the lighting equipment being associated with the identification information being acquired by the second acquisition unit to a second state being associated with the operation signal.

Cited Document 2 describes “an apparatus that controls an environment such as lighting or sound according to a position of a person using a foot position detection means or an activity amount detection unit”.

Cited Document 2 describes that the foot position detection means detects a foot position of each person in a room from a human pixel block being separated for each person in the room by a number-of-people detection means, and a thermal image. It is described that the number-of-people detection means decides the number of people from the number of human pixel blocks in the room, which are detected by a human area detection means, and the number of pixels of each block. It is described that the human area detection means detects an area of a human part from the thermal image and outputs the human pixel block.

Further, Cited Document 2 describes that the activity amount detection unit detects an activity amount for each individual or a representative activity amount in the room from individual information being an output from an individual information output unit. It is described that the individual information output unit extracts the individual information relating to a person in the room, based on the human pixel block being detected by the human area detection means.

Cited Document 3 describes a work place environment management system including a worker recognition means being capable of scanning an entire area of a work place being a target and a data processing means.

The data processing means described in Cited Document 3 decides a seating state of a worker in a plurality of seating recognition areas assumed in the work place from scan information from the worker recognition means, provides a worker ID in each seating recognition area, and determines a worker. Further, the data processing means recognized a working state of the worker in the work place, and issues operation command information relating to a facility in the work place according to the working state. Cited Document 3 describes that a control target facility is task lighting, ambient lighting, and the like.

Cited Document 4 describes an air conditioner including an image capturing unit that captures an image of a room to be air-conditioned and a control unit. The control unit described in Cited Document 4 recognizes whether a person is present or absent in the room to be air-conditioned, a posture of a person present in the room to be air-conditioned, and brightness in the room to be air-conditioned from image information being captured by the image capturing unit, estimates an action of the person, and switches an operation condition of an air-conditioning operation accordingly.

Cited Document 5 describes a data processing apparatus including a user extraction means, a condition decision means, and an environment adjustment means.

The user extraction means described in Cited Document 5 extracts user image data from space image data relating to a user utilization space, which is acquired by a space image capturing device, the user utilization space being a space in which an environment adjustment device for adjusting a space environment is installed and a space being freely accessible for a general user.

The condition decision means described in Cited Document 5 decides at least a clothing condition of a general user from the image data being extracted, and generates user condition data. The environment adjustment means described in Cited Document 5 outputs operation control data to the environment adjustment device according to the user condition data being generated. Cited Document 5 describes that the environment adjustment device includes at least one of a lighting facility, an air-conditioning facility, and a sound facility in the user utilization space.

Note that, Patent Document 6 describes a technique of computing a feature value of each of a plurality of keypoints of a human body included in an image, searching for an image including a human body in a similar pose or a human body movement similarly, based on the feature value being computed, and collectively classifying human bodies in the similar pose or movement. Further, Non-Patent Document 1 describes a technique relating to skeleton estimation of a person.

### RELATED DOCUMENT

### Patent Document

Patent Document 1: Japanese Patent Application Publication No. 2014-078398
Patent Document 2: Japanese Patent Application Publication No. H06-180139
Patent Document 3: Japanese Patent Application Publication No. 2011-188082
Patent Document 4: Japanese Patent Application Publication No.

2015-021634
Patent Document 5: Japanese Patent Application Publication No. 2009-192171
Patent Document 6: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pp. 7291 to 7299

### DISCLOSURE OF THE INVENTION

### Technical Problem

The lighting control apparatus described in Patent Document 1 controls lighting equipment by using mobile equipment carried by a person in a control target area, and an operation signal. Thus, when a person in the control target area does not carry mobile equipment, it is difficult to improve convenience regarding lighting.

The apparatus described in Patent Document 2 detects a foot position or an activity amount of a person in a room, based on a thermal image. Thus, it is difficult to improve convenience regarding lighting by using at least a factor other than a foot position or an activity amount of a person in a room.

In the work place environment management system described in Patent Document 3, a facility in a work place is a control target. Thus, it is difficult to improve convenience regarding lighting in various target areas.

The technique described in Patent Document 4 is a technique for controlling an air conditioner. Thus, it is difficult to improve convenience regarding lighting by the technique described in this document.

The data processing apparatus described in Cited Document 5 controls an environment adjustment device, based on a clothing condition of a general user. Thus, it is difficult to improve convenience regarding lighting by using at least a factor other than a clothing condition of a general user.

Note that, Patent Document 6 and Non-Patent Document 1 does not mention application to lighting equipment control. Thus, it is difficult to improve convenience regarding lighting by the techniques described in Patent Document 6 and Non-Patent Document 1.

In view of the above-mentioned problem, one example of objects of the present invention is to provide a lighting management apparatus, a lighting management system, a lighting management method, and a storage medium that solve a problem of improving convenience regarding lighting.

### Solution to Problem

According to one aspect of the present invention, there is provided a lighting management apparatus including:
a first acquisition unit that acquires analysis information based on a result being estimated by using an analysis of an image being acquired by photographing a target area; and
a signal generation unit that generates a control signal for controlling one or a plurality of pieces of lighting equipment being associated with the target area, by using the analysis information and a usage purpose of the target area, wherein
the analysis information includes a pose of a person present in the target area.

According to one aspect of the present invention, there is provided a lighting management system including:
the lighting management apparatus described above;
one or a plurality of photographing apparatuses that generate image information including the image being acquired by photographing the target area; and
the one or plurality of pieces of lighting equipment being associated with the target area.

According to one aspect of the present invention, there is provided a lighting management method including,
by a computer:
   acquiring analysis information based on a result being estimated by using an analysis of an image being acquired by photographing a target area; and
   generating a control signal for controlling one or a plurality of pieces of lighting equipment being associated with the target area, by using the analysis information and a usage purpose of the target area, wherein
the analysis information includes a pose of a person present in the target area.

According to one aspect of the present invention, there is provided a storage medium storing a program for causing a computer to execute:
acquiring analysis information based on a result being estimated by using an analysis of an image being acquired by photographing a target area; and
generating a control signal for controlling one or a plurality of pieces of lighting equipment being associated with the target area, by using the analysis information and a usage purpose of the target area, wherein
the analysis information includes a pose of a person present in the target area.

### Advantageous Effects of Invention

According to the present invention, it is possible to provide a lighting management apparatus, a lighting management system, a lighting management method, and a storage medium that solve a problem of improving convenience regarding lighting.

### BRIEF DESCRIPTION OF THE DRAWINGS

FIG. 1 is a diagram illustrating an overview of a lighting management apparatus according to a first example embodiment.

FIG. 2 is a diagram illustrating an overview of a lighting management system according to the first example embodiment.

FIG. 3 is a flowchart illustrating an overview of lighting management processing according to the first example embodiment.

FIG. 4 is a diagram illustrating a detailed configuration example of the lighting management system according to the first example embodiment.

FIG. 5 is a plan view illustrating an installation example of photographing apparatuses PEa to PEe and lighting equipment LEa to LEh in target areas TAa to Tad, and one example of persons Pa to Pd present in the target areas TAa to TAd according to the first example embodiment.

FIG. 6 is a diagram illustrating a configuration example of a signal generation unit according to the first example embodiment.

FIG. 7 is a diagram illustrating one example of area information according to the first example embodiment.

FIG. 8 is a diagram illustrating one example of lighting information according to the first example embodiment.

FIG. 9 is a diagram illustrating one example of control pattern information according to the first example embodiment.

FIG. 10 is a diagram illustrating a physical configuration example of the lighting management apparatus according to the first example embodiment.

FIG. 11 is a flowchart illustrating a detailed example of the lighting management processing according to the first example embodiment.

FIG. 12 is a plan view illustrating another example of the persons Pa to Pd present in the target areas TAa to TAd according to the first example embodiment.

FIG. 13 is a diagram illustrating a configuration example of a lighting management system in a third modification example.

FIG. 14 is a diagram illustrating one example of control pattern information according to a second example embodiment.

FIG. 15 is a diagram illustrating one example of control pattern information according to a third example embodiment.

FIG. 16 is a diagram illustrating a configuration example of a lighting management system according to a fourth example embodiment.

FIG. 17 is a flowchart illustrating one example of prediction control processing according to the present example embodiment.

### EXAMPLE EMBODIMENTS

Example embodiments of the present invention are described below with reference to the drawings. Note that, in all the drawings, a similar constituent element is denoted with a similar reference sign, and description therefor is omitted as appropriate.

### First Example Embodiment

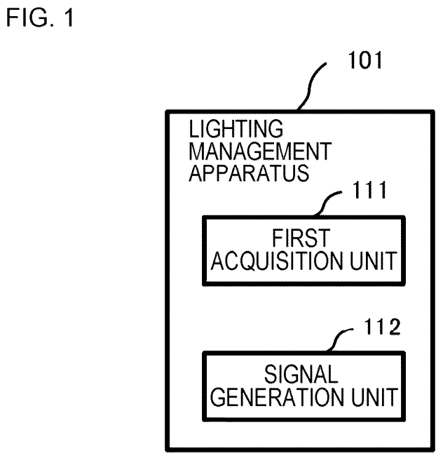

FIG. 1 is a diagram illustrating an overview of a lighting management apparatus 101 according to a first example embodiment. The lighting management apparatus 101 includes a first acquisition unit 111 and a signal generation unit 112.

The first acquisition unit 111 acquires analysis information based on a result being estimated by using an analysis of an image being acquired by photographing a target area TA. The analysis information includes a pose of a person P present in the target area TA. The signal generation unit 112 generates a control signal for controlling one or a plurality of pieces of lighting equipment LE being associated with the target area TA, by using the analysis information and a usage purpose of the target area TA.

According to the lighting management apparatus 101, it is possible to provide the lighting management apparatus 101 that solves a problem of improving convenience regarding lighting.

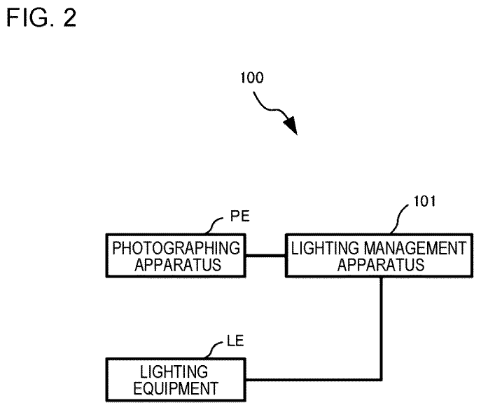

FIG. 2 is a diagram illustrating an overview of a lighting management system 100 according to the first example embodiment. The lighting management system 100 includes the lighting management apparatus 101, one or a plurality of photographing apparatuses PE that generate image information including an image being acquired by photographing the target area TA, and one or a plurality of pieces of lighting equipment LE being associated with the target area TA.

According to the lighting management system 100, it is possible to provide the lighting management system 100 that solves a problem of improving convenience regarding lighting.

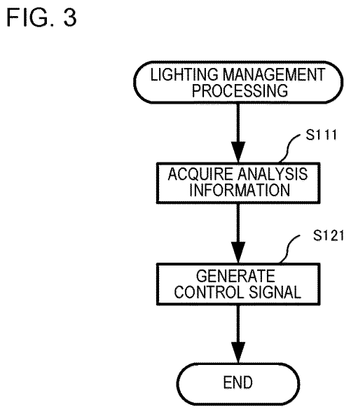

FIG. 3 is a flowchart illustrating an overview of lighting management processing according to the first example embodiment.

The first acquisition unit 111 acquires analysis information based on a result being estimated by using an analysis of an image being acquired by photographing the target area TA (step S111). The analysis information includes a pose of the person P present in the target area TA. The signal generation unit 112 generates a control signal for controlling the one or plurality of pieces of lighting equipment LE being associated with the target area TA, by using the analysis information and a usage purpose of the target area TA (step S121).

According to the lighting management processing, it is possible to provide a lighting management method that solves a problem of improving convenience regarding lighting.

Hereinafter, a detailed example of the lighting management system 100 according to the first example embodiment is described.

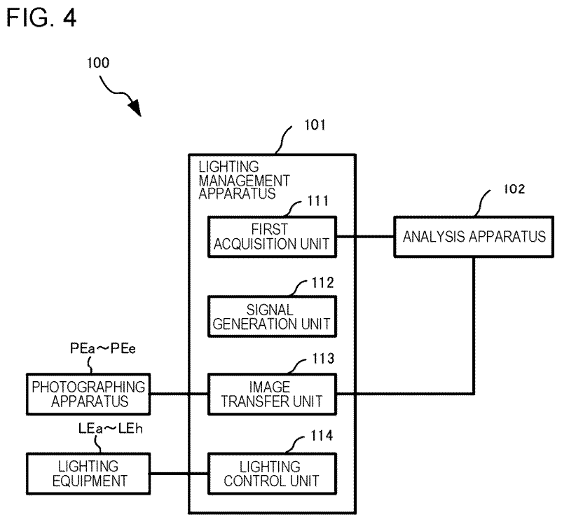

FIG. 4 is a diagram illustrating a detailed configuration example of the lighting management system 100 according to the present example embodiment. The lighting management system 100 according to the present example embodiment is a system for managing lighting equipment LEa to LEh being installed in target areas TAa to TAd. The lighting management system 100 includes photographing apparatuses PEa to PEe, the lighting equipment LEa to LEh, the lighting management apparatus 101, and an analysis apparatus 102.

The lighting management apparatus 101, and the photographing apparatuses PEa to PEe and the lighting equipment LEa to LEh are connected to each other via a communication network being wired, wireless, or a combination thereof (for example, a local area network (LAN)). The lighting management apparatus 101, and the photographing apparatuses PEa to PEe and the lighting equipment LEa to LEh transmit and receive information mutually via the communication network.

The lighting management apparatus 101 and the analysis apparatus 102 are connected to each other via a communication network being wired, wireless, or a combination thereof (for example, a LAN and the Internet). The lighting management apparatus 101 and the analysis apparatus 102, and the photographing apparatuses PEa to PEe and the lighting equipment LEa to LEh transmit and receive information mutually via the communication network.

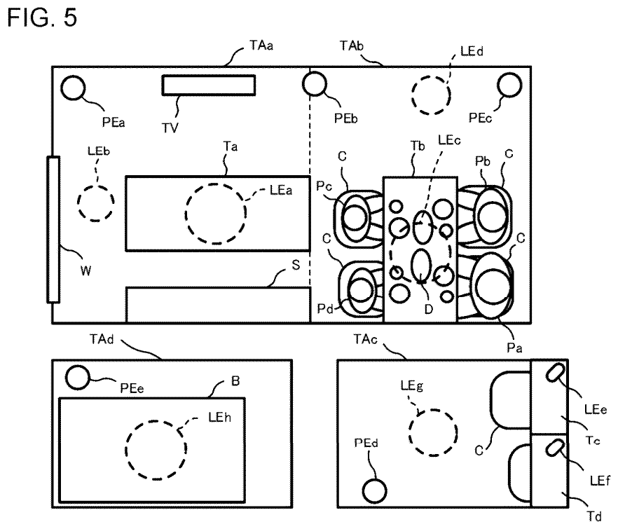

FIG. 5 is a plan view illustrating an installation example of the photographing apparatuses PEa to PEe and the lighting equipment LEa to LEh in the target areas TAa to TAd according to the present example embodiment.

Each of the photographing apparatuses PEa to PEe is an example of the photographing apparatus PE. For example, each of the photographing apparatuses PEa to PEe is a camera, and is installed on a ceiling, a wall, or the like. Each of the photographing apparatuses PEa to PEe photographs the target area TA being associated therewith, and generates image information including an image being photographed. The image information is information in which a photograph identifier (ID) being information for identifying each of the photographing apparatuses PEa to PEe, a photograph time, and an image are associated with one another.

For example, an image being generated by each of the photographing apparatuses PEa to PEe is an image based on visible light.

Each of pieces of the lighting equipment LEa to LEh is an example of the lighting equipment LE. Each of the target areas TAa to TAd is an example of the target area TA included in a house that persons Pa to Pd live in. The target areas TAa to TAd are a living room, a dining room, a child's room, and a bed room, respectively. Each of the persons Pa to Pd is an example of the person P present in the target area TA.

The photographing apparatuses PEa and PEb photograph the target area TAa (living room). The photographing apparatuses PEa and PEb generate the image information including an image being acquired by photographing the target area TAa.

In the target area TAa illustrated in FIG. 5, a television TV and a sofa S are installed, and a table Ta is installed therebetween. On a ceiling above the table Ta, the lighting equipment LEa is installed. On a ceiling near a window W (a left side of the lighting equipment LEb in FIG. 5), the lighting equipment is installed.

The photographing apparatuses PEb and PEc photograph the target area TAb (dining room). The photographing apparatuses PEb and PEc generate the image information including an image being acquired by photographing the target area TAb.

In the target area TAb illustrated in FIG. 5, the persons Pa to Pd seated on chairs C around a table Tb on which dishes D are placed have a meal. On a ceiling above the table Tb, the lighting equipment LEc is installed. Further, on a ceiling on a side of the lighting equipment LEc (an upper side in FIG. 5), the lighting equipment LEd is installed.

The photographing apparatus PEd photographs the target area TAc (child's room). The photographing apparatus PEd generates the image information including an image being photographed the image being acquired by photographing the target area TAc.

In the target area TAc illustrated in FIG. 5, desks Tc and Td are installed, and the lighting equipment LEe and LEf are placed on the desks Tc and Td, respectively. At a substantially center of a ceiling of the target area TAc, the lighting equipment LEg is installed.

The photographing apparatus PEe photographs the target area TAd (bed room). The photographing apparatus PEe generates the image information including an image being acquired by photographing the target area TAd.

In the target area TAd illustrated in FIG. 5, a bed B is installed. At a substantially center of a ceiling of the target area TAd, the lighting equipment LEh is installed.

Hereinafter, when the target areas TAa to TAd are not distinguished from one another, each of those is also referred to as a target area TA. When the photographing apparatuses PEa to PEe are not distinguished from one another, each of those is also referred to as a photographing apparatus PE. When the lighting equipment LEa to LEh are not distinguished from one another, each of those is also referred to as lighting equipment LE.

### Functional Configuration Example of Lighting Management Apparatus 101

Specifically, as illustrated in FIG. 4, the lighting management apparatus 101 according to the present example embodiment includes the first acquisition unit 111, the signal generation unit 112, an image transfer unit 113, and a lighting control unit 114 in a functional sense.

As described above, the first acquisition unit 111 acquires analysis information based on a result being estimated by using an analysis of an image being acquired by photographing the target area TA. The first acquisition unit 111 according to the present example embodiment acquires the analysis information from the analysis apparatus 102. The first acquisition unit 111 may store the analysis information.

The analysis information includes a pose of the person P present in the target area TA. For example, the pose of the person P included in the analysis information is indicated by using a skeleton model being acquired by modeling a skeleton of a person. For example, the pose includes a standing pose (standing position), a sitting pose (sitting position), a lying pose (lying position), a squatting pose, a crouching pose, and the like. The sitting position may be subdivided into a forward-leaning sitting position involving sitting in a forward-leaning manner, a backward-leaning position involving sitting and leaning against a backrest, and the like.

Further, the pose may include whether to be a still pose. The still pose is a pose being kept simply as the same pose (for example, simply standing, or simply sitting) for a predetermined time (for example, five seconds) or more. More specifically, the still pose indicates that the same pose is kept for the predetermined time or more without a predetermined movement (for example, watching television, writing, browsing a book, a document, a tablet terminal, a mobile terminal, or the like, eating, performing desk work).

The analysis information may include at least one of the number of persons P present in the target area TA (including zero), orientation, and a position.

The signal generation unit 112 generates a control signal for controlling the one or plurality of pieces of lighting equipment LE being associated with the target area TA, by using the analysis information being acquired by the first acquisition unit 111 and a usage purpose of the target area TA. The control signal includes at least one of lighting-on (on) or lighting-off (off), brightness, and a color of the lighting equipment LE. The signal generation unit 112 may store a history of the control signal.

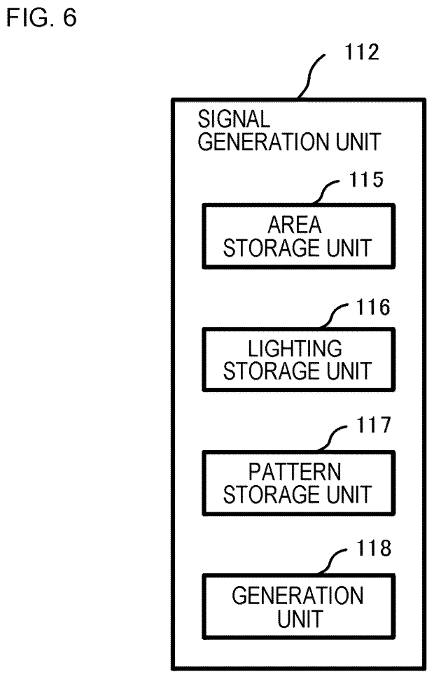

FIG. 6 is a diagram illustrating configuration example of the signal generation unit 112 according to the present example embodiment. The signal generation unit 112 includes an area storage unit 115 for storing area information 115a, a lighting storage unit 116 for storing lighting information 116a, a pattern storage unit 117 for storing control pattern information 117a, and a generation unit 118.

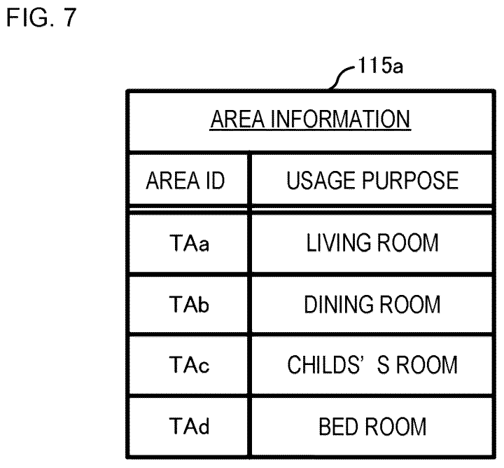

FIG. 7 is a diagram illustrating one example of the area information 115a according to the present example embodiment. The area information 115a is information in which an area ID and a usage purpose are associated with each other. For example, the area information 115a is set in advance to the area storage unit 115, based on an input from a user.

The area ID is information for identifying the target area TA. The usage purpose is a usage purpose of the target area TA being identified by using the area ID associated with the usage purpose.

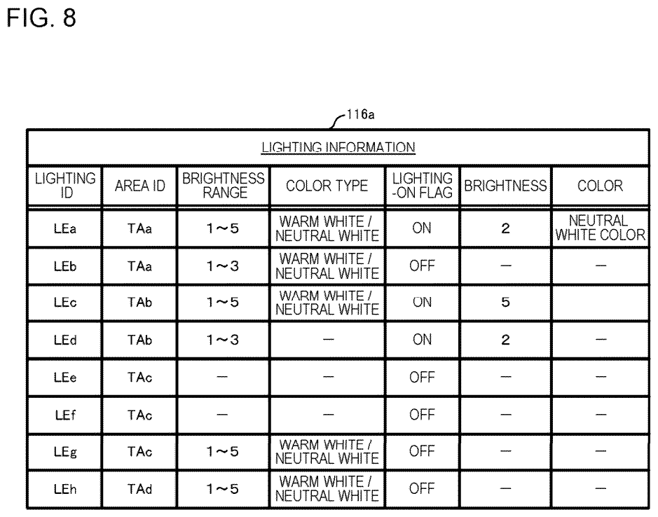

FIG. 8 is a diagram illustrating one example of the lighting information 116a according to the present example embodiment. The lighting information 116a includes a lighting ID, the area ID, a brightness range, a color type, a lighting-on flag, brightness, and a color.

The lighting ID is information for identifying the lighting equipment LE. The area ID is an area ID of the target area TA being illuminated by the lighting equipment LE being identified by using the lighting ID associated with the area ID. In other words, in the present example embodiment, the lighting information 116a associates the one or plurality of pieces of lighting equipment LE with the target area TA

The brightness range and the color type indicate a range of brightness and a color type, respectively, that can be set to the lighting equipment LE being identified by using the lighting ID associated with the brightness range and the color type.

“1 to 3” of the brightness range indicates that color brightness can be set in three stages to the lighting equipment LE being identified by using the lighting ID associated with the brightness range. “1 to 5” of the brightness range indicates that color brightness can be set in five stages to the lighting equipment LE being identified by using the lighting ID associated with the brightness range. “-” of the brightness range indicates that brightness cannot be set to the lighting equipment LE being identified by using the lighting ID associated with the brightness range.

Note that, with regard to the lighting equipment LE to which brightness can be set, brightness to be set is not limited to three stages or five stages, and is only required to be two or more stages.

“Warm white/neutral white” of the color type indicates that two types of colors including a warm white color and a neutral white color can be set to the lighting equipment LE being identified by using the lighting ID associated with the color type. For example, the warm white color is an orange-tinted color with a color temperature of approximately 3,000 Kelvin (K). For example, the neutral white color is a whitish color with a color temperature of approximately 5,000 K. “-” of the color type indicates that a color cannot be set to the lighting equipment LE being identified by using the lighting ID associated with the color type.

Note that, with regard to the lighting equipment LE to which a color can be set, a color to be set is not limited to two types, and may be three or more types. Further, the color to be set is not limited to the warm white color and the neutral white color, and may be any color being decided appropriately for the lighting equipment LE.

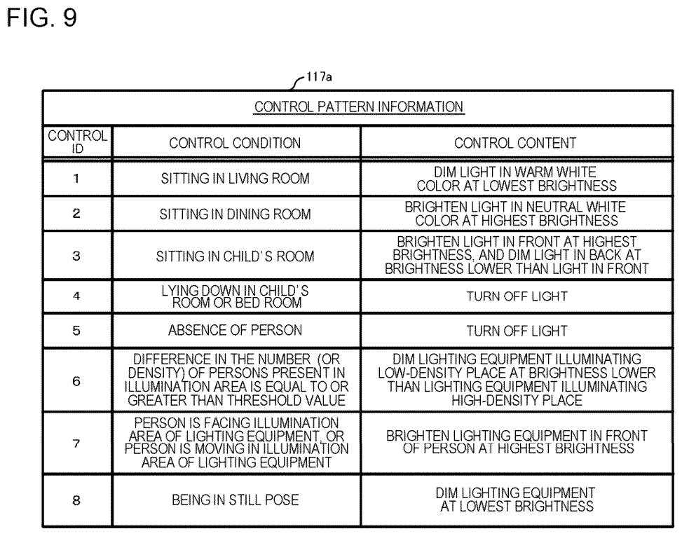

FIG. 9 is a diagram illustrating one example of the control pattern information 117a according to the present example embodiment. The control pattern information 117a includes a control pattern in which a control condition and a control content are associated with each other. The control pattern information 117a illustrated in FIG. 9 is information in which a control ID and a control pattern are associated with each other. The control pattern information 117a is set in advance.

The control ID is information for identifying the control pattern included in the control pattern information 117a. In FIG. 9, the control ID is indicated by, but not limited to, a numeral, and any symbol may be provided thereto.

For example, each one of control patterns of control IDs “1”, “2”, and “4” is an example including a control condition based on the usage purpose of the target area TA and the pose. The control pattern of the control ID “1” is an example of control for achieving comfortable relaxation in the living room. The control pattern of the control ID “2” is an example of control for enjoying a meal comfortably in the dining room. The control pattern of the control ID “4” is an example of control for achieving comfortable sleep.

A control condition of a control ID “3” is an example including a control condition based on the usage purpose and the orientation and pose of the person P. The control pattern of the control ID “3” is an example of control for facilitating studying in the child's room.

A control condition of a control ID “5” is an example including a control condition based on the number of persons P. A control condition of a control ID “6” is an example including a control condition based on a position of the person P. The control patterns of the control IDs “5” and “6” are examples of control for reducing power consumption.

A control condition of a control ID “7” is an example including a control condition based on the orientation of the person P. The control condition of the control ID “7” is an example of control for achieving a safe moving action of the person P who is about to move or the person P who is moving. Note that, a condition that “a person faces a direction of an illumination area of the lighting equipment” included in the control condition of the control ID “7” may further include being in a still pose, in other words, a condition that “a person is in a still pose facing the direction of the illumination area of the lighting equipment”, for example.

A control condition of a control ID “8” is an example including a control condition based on a still state. The control condition of the control ID “8” is an example of control for achieving comfortable relaxation for the person P in a still state and also reducing power consumption.

Refer back to FIG. 6.

The generation unit 118 generates a control signal for controlling the one or plurality of pieces of lighting equipment LE being associated with the target area TA, by using the analysis information being acquired by the first acquisition unit 111 and the usage purpose of the target area TA.

Specifically, the generation unit 118 generates the control signal, based on the analysis information, the area information 115a, the lighting information 116a, and the control pattern information 117a.

More specifically, the generation unit 118 stores information in which a photograph area of each of the photographing apparatuses PE and the target area TA are associated with each other. The generation unit 118 determines, based on the information, the target area TA being associated with an apparatus ID of the photographing apparatus PE that photographs an image being a source of the analysis information, and determines the target area TA being associated with the analysis information. The generation unit 118 decides whether the control condition is satisfied, based on the target area TA being determined, the area information 115a, and the analysis information.

When the control condition is satisfied, the generation unit 118 generates the control signal for controlling the lighting equipment LE being identified by using the lighting ID associated with the target area TA (area ID), based on the control content being associated with the control condition and the lighting information 116a.

Refer back to FIG. 4.

The image transfer unit 113 acquires image information being generated by the photographing apparatus PE from the photographing apparatus PE. The image transfer unit 113 transfers the image information being acquired to the analysis apparatus 102. The image transfer unit 113 may store the image information for a predetermined period or all the information.

The lighting control unit 114 outputs a control signal being generated by the signal generation unit 112 to the one or plurality of pieces of lighting equipment LE.

### Functional Configuration Example of Analysis Apparatus 102

Refer back to FIG. 4.

The analysis apparatus 102 is an apparatus that analyzes an image included in image information being acquired when the image information is acquired from the lighting management apparatus 101. The analysis apparatus 102 includes a function of analyzing an image in order to acquire analysis information.

For example, the analysis function included in the analysis apparatus 102 includes one or a plurality of (1) an object detection function, (2) a face analysis function, (3) a human shape analysis function, (4) a pose analysis function, (5) an action analysis function, (6) an external appearance attribute analysis function, (7) a gradient feature analysis function, (8) a color feature analysis function, (9) a flow line analysis function, and the like.
(1) In the object detection function, an object is detected from an image. In the object detection function, a position, a size, and the like of the object in the image can also be acquired. An example of a model to be applied to object detection processing includes you only look once (YOLO). The object includes a person and an item. For example, in the object detection function, the person P, the dish D, the television TV, the tables Ta to Td, the sofa S, the chair C, the bed B, and the like are detected.
(2) In the face analysis function, detection of a face of a person from an image, extraction of a feature value of the face being detected (face feature value), categorization (classification) of the face being detected, and the like are executed. In the face analysis function, a position of the face in the image can also be acquired. In the face analysis function, identity of a person being detected from different images can also be decided based on a similarity degree of face feature values of the person being detected from the different images, or the like.
(3) In the human shape analysis function, extraction of a human body feature value (for example, a value indicating an overall feature such as a body shape such as obese or thin, a height, and clothes) of a person included in an image, categorization (classification) of the person included in the image, and the like are executed. In the human shape analysis function, a position of the person in the image can also be determined. In the human shape analysis function, identity of a person included in different images can also be decided based on the human body feature values of the person included in the different images, or the like.
(4) In the pose analysis function, a skeleton model is prepared by detecting a joint of a person from an image, connecting the joints to each other, and modeling a skeleton of the person P. Further, in the pose analysis function, estimation of a pose of a person, extraction of a feature value of the pose being estimated (pose feature value), categorization (classification) of the person included in the image, and the like are executed by using information relating to the skeleton model. In the pose analysis function, identity of a person included in different images can also be decided based on the pose feature values of the person included in the different images, or the like.

For example, in the pose analysis function, a pose such as a standing position, a sitting position, a lying position, a squatting pose, a crouching pose, a forward-leaning sitting position, and a backward-leaning sitting position is estimated from an image, and the pose feature value indicating each of the poses is extracted. Further, for example, in the pose analysis function, a pose of the person P with respect to an item being detected by using the object detection function or the like is estimated from an image, and the pose feature value indicating the pose can be extracted.

The pose feature value is a feature value indicating the skeleton model.

For example, the techniques disclosed in Patent Document 3 and Non-Patent Document 1 are applicable to the pose analysis function.
(5) In action analysis processing, a movement of a person is estimated by using information relating to a skeleton model, a change of a pose, or the like, and extraction of a feature value of the movement of the person (movement feature value), categorization (classification) of the person included in the image, and the like can be executed. In the action analysis processing, by using the information relating to the skeleton model, a height of the person can also be estimated, and a position of the person in the image can also be determined. For example, in the action analysis processing, an action such as a change or transition of a pose, and a moving action (a change or transition of a position) can be extracted from an image, and a movement feature value of the action can be extracted.
(6) In the external appearance attribute analysis function, an external appearance attribute associated with a person can be recognized. In the external appearance attribute analysis function, extraction of a feature value relating to the external appearance attribute being recognized (external appearance attribute feature value), categorization (classification) of the person being included in an image, and the like are executed. The external appearance attribute is an attribute relating to an external appearance, and includes, for example, one or more of a color of clothes, a color of a shoe, a hair style, a hat or a necktie, wearing of glasses, and the like.
(7) In the gradient feature analysis function, a feature value of a gradient (gradient feature value) in an image is extracted. For example, techniques such as SIFT, SURF, RIFF, ORB, BRISK, CARD, and HOG are applicable to gradient feature detection processing.
(8) In the color feature analysis function, an object can be extracted from an image, and extraction of a feature value of a color of the object being detected (color feature value), categorization (classification) of the object being detected, and the like can be executed. The color feature value is a color histogram, for example.
(9) In the flow line analysis function, a flow line (a trajectory of a moving action) of a moving body included in an image can be acquired by using a result of the identity decision, a result of the classification, and the like in any of the analysis functions (2) to (8) described above, for example. Specifically, for example, the flow line of a moving body can be acquired by connecting moving bodies being decided as the same moving body between different images in time series. Note that, in the flow line analysis function, when a video being photographed by the plurality of photographing apparatuses PE that photograph different photograph areas is acquired, a flow line over a plurality of images being acquired by photographing the different photograph areas can also be acquired.

The above-mentioned analysis functions included in the analysis apparatus 102 may be configured in such a way that the analysis results can be used mutually therebetween. Further, the analysis apparatus 102 may include a function (analysis function) of analyzing an image by using the above-mentioned analysis functions and acquiring the number of persons P, orientation of the person P, and the like.

Note that, the analysis functions described herein are examples of an image analysis method of acquiring the analysis information, and a method of acquiring the analysis information is not limited thereto.

The functional configuration of the lighting management system 100 according to the first example embodiment is mainly described above. Hereinafter, a physical configuration of the lighting management system 100 according to the present example embodiment is described.

### Physical Configuration Example of Lighting Management System 100

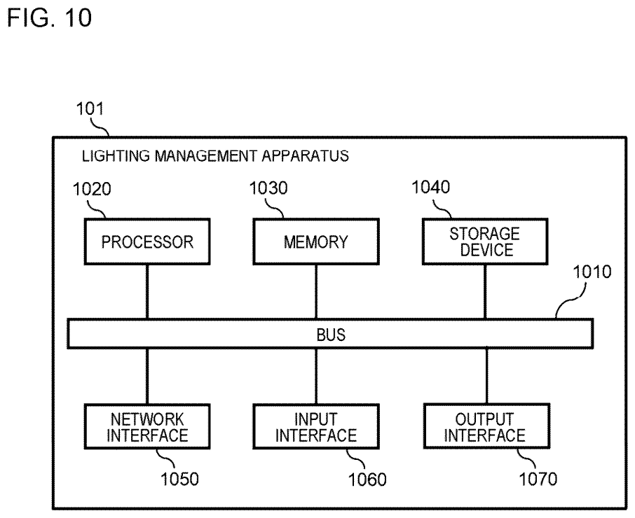

For example, the lighting management apparatus 101 is a general-purpose computer in a physical sense. FIG. 10 is a diagram illustrating a physical configuration example of the lighting management apparatus 101 according to the present example embodiment.

For example, the lighting management apparatus 101 includes a bus 1010, a processor 1020, a memory 1030, a storage device 1040, a network interface 1050, an input interface 1060, and an output interface 1070.

The bus 1010 is a data transmission path in which the processor 1020, the memory 1030, the storage device 1040, the network interface 1050, the input interface 1060, and the output interface 1070 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a memory card, a read only memory (ROM), or the like. The storage device 1040 stores a program module achieving the function of the lighting management apparatus 101. The processor 1020 reads each of the program modules on the memory 1030 and executes the read program module, and thereby each of the functions associated with each of the program modules is achieved.

The network interface 1050 is an interface for connecting the lighting management apparatus 101 to a network.

The input interface 1060 is an interface for inputting information by a user, and is configured, for example, by a touch panel, a keyboard, a mouse, or the like.

The output interface 1070 is an interface for providing information to a user, and is configured, for example, by a liquid crystal panel, an organic electro-luminescence (EL) panel, or the like.

For example, the analysis apparatus 102 is a general-purpose computer in a physical sense. Similarly to the lighting management apparatus 101, the analysis apparatus 102 includes a bus 1010, a processor 1020, a memory 1030, a storage device 1040, and a network interface 1050 (see FIG. 10).

The storage device 1040 included in the analysis apparatus 102 stores a program module achieving the function of the analysis apparatus 102. The network interface 1050 included in the analysis apparatus 102 is an interface for connecting the analysis apparatus 102 to a network. Except for those points, the analysis apparatus 102 may be configured similarly to the lighting management apparatus 101 in a physical sense.

The physical configuration of the lighting management system 100 according to the first example embodiment is mainly described above. Hereinafter, an operation of the lighting management system 100 according to the present example embodiment is described.

### (Operation of Lighting Management System 100)

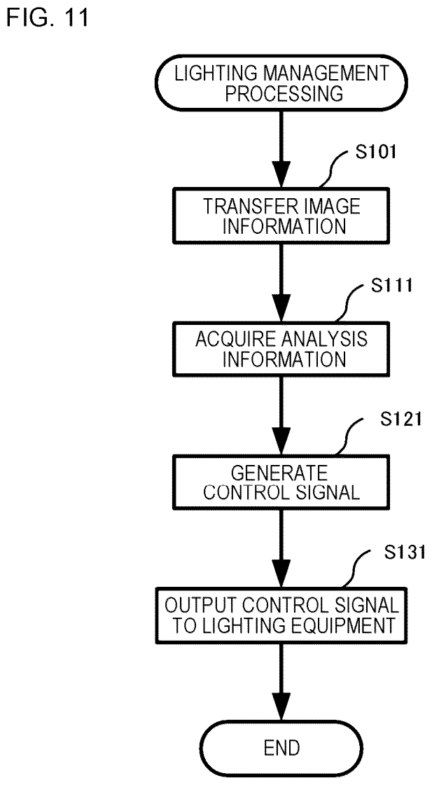

FIG. 11 is a flowchart illustrating a detailed example of lighting management processing according to the first example embodiment. The lighting management processing is processing for managing the lighting equipment LEa to LEh being installed in the target areas TAa to TAd. During its operation, the lighting management apparatus 101 executes the lighting management processing in a repeated manner. Further, during its operation, the photographing apparatus PE transmits image information including an image being photographed to the lighting management apparatus 101 in real time, for example.

The image transfer unit 113 transfers image information being acquired from the photographing apparatus PE to the analysis apparatus 102 (step S101).

Specifically, for example, the image transfer unit 113 transfers the image information being acquired from each of the photographing apparatuses PEa to PEe to the analysis apparatus 102.

Herein, the analysis apparatus 102 acquires the image information being transferred in step S101 from the lighting management apparatus 101. Note that, the analysis apparatus 102 may acquire the image information from the photographing apparatus PE without intermediation of the lighting management apparatus 101.

The analysis apparatus 102 analyzes the image included in the image information being acquired, by using the above-mentioned analysis function, and generates analysis information. The analysis apparatus 102 transmits the analysis information being generated to the lighting management apparatus 101.

The first acquisition unit 111 acquires, from the analysis apparatus 102, the analysis information based on a result being estimated by using an analysis of the image being acquired by photographing the target area TA (step S111).

The analysis information includes a pose of the person P present in the target area TA. Further, in the present example embodiment, the analysis information further includes the number of persons P present in the target area TA, orientation, and a position.

The signal generation unit 112 generates a control signal for controlling the one or plurality of pieces of lighting equipment LE being associated with the target area TA, by using the analysis information being acquired in step S111 and a usage purpose of the target area TA (step S121).

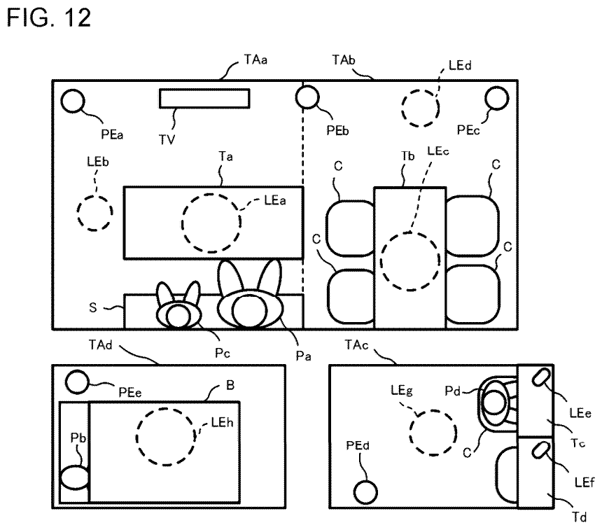

Specifically, for example, it is assumed that the target areas TAa to TAd are shifted from a state illustrated in FIG. 5 to a state illustrated in FIG. 12.

For example, in the target area TAa (living room) illustrated in FIG. 12, it is assumed that the persons Pa and Pc sit on the sofa S and watch television. In this case, the analysis information based on an image being acquired by photographing the target area TAa includes that the two person P sit on the sofa S in the target area TAa. The generation unit 118 determines the usage purpose of the target area TAa being associated with the analysis information as the living room, based on the area information 115a.

The generation unit 118 decides whether a control condition relating to the living room (for example, the control ID “1” illustrated in FIG. 9) and the control condition not relating to the usage purpose of the target area TA (for example, the control IDs “5” to “8” illustrated in FIG. 9) are satisfied, based on the analysis information.

The analysis information includes that the person P sits, and hence the generation unit 118 decides that the control condition being associated with the control ID “1” is satisfied. Further, there are the two persons P in a vicinity of the table Ta being an illumination area of the lighting equipment LEa, and there is no person P in the vicinity of the window W of Tab being an illumination area of the lighting equipment LEb. When the control condition of the control ID “6” is that “a difference in number of persons P present in the illumination areas is two or more”, the generation unit 118 decides that the control condition being associated with the control ID “6” is satisfied in this case. The generation unit 118 decides that the control conditions being associated with the control IDs “5” and “7” are not satisfied.

According to a control content being associated with the control ID “1”, the generation unit 118 turns on the lighting equipment LEa and LEb being associated with the target area TAa in the warm white color at lowest brightness (for example, brightness “1”). Further, according to the control content being associated with the control ID “6”, the generation unit 118 dims the lighting equipment LEb illuminating a low-density place at brightness lower than the lighting equipment LEa illuminating a high-density place. Herein, for example, it is assumed that, in application, a control pattern including the control condition not relating to the usage purpose of the target area TA takes precedence over the control pattern including the control condition relating to the usage purpose of the target area TA.

In this case, according to the control contents being associated with the control IDs “1” and “6”, the generation unit 118 generates a control signal for turning on the lighting equipment LEa in the warm white color at brightness “1”. In addition to this, the generation unit 118 generates the control signal for turning off the lighting equipment LEb in order to dim the lighting equipment LEb at brightness lower than brightness “1”. With this, power consumption can be reduced while the person P in the living room is relaxed.

While watching television, the person P may remain in a seating pose for five seconds or more, for example. Thus, the analysis information relating to the target area TAa may also include being in a still pose. Thus, the generation unit 118 decides that the control condition being associated with the control ID “8” is satisfied. Even with this decision, the control content being associated with the control condition is dimming the lighting equipment at lowest brightness. Thus, there is no contradiction with the above-mentioned control signal, and power consumption can be reduced while the person P in the living room is relaxed.

Herein, for example, it is assumed that the person Pa or Pc in the living room further moves from the state illustrated in FIG. 12 and enters the illumination area of the lighting equipment LEd. In this case, the control ID “7” is satisfied, and hence the generation unit 118 generates the control signal for turning on the lighting equipment LEd at highest brightness. The lighting equipment LEd is equivalent to illumination in a passageway such as a corridor, and achieves a safe moving action of the person P.

For example, in the target area TAb (dining room) illustrated in FIG. 12, there is no person P. Thus, the analysis information based on an image being acquired by photographing the target area TAb includes that the number of persons P in the target area TAb is zero. The generation unit 118 determines the usage purpose of the target area TAb being associated with the analysis information as the dining room, based on the area information 115a.

The generation unit 118 decides whether the control condition relating to the dining room (for example, the control ID “2” illustrated in FIG. 9) and the control condition not relating to the usage purpose of the target area TA (for example, the control IDs “5” to “8” illustrated in FIG. 9) are satisfied, based on the analysis information.

The analysis information includes that the number of persons P is zero, and hence the generation unit 118 decides that the control condition being associated with the control ID “2” is not satisfied. It is decided that, among the control IDs “5” to “8”, the control condition being associated with the control ID “5” is satisfied.

According to the control content being associated with the control ID “5”, the generation unit 118 generates the control signal for turning off the lighting equipment LEc and LEd being associated with the target area TAb in the warm white color. With this, power consumption can be reduced.

For example, in the target area TAc (child's room) illustrated in FIG. 12, it is assumed that the person Pd is facing the desk Tc, sitting on the chair C, and studying. The analysis information based on an image being acquired by photographing the target area TAc includes that one person P sits in the target area TAc. In general, studying involves writing and flipping a page of a document or the like, and hence a pose is not a still pose. Thus, the analysis information does not include being in a still pose. The generation unit 118 determines the usage purpose of the target area TAc being associated with the analysis information as the child's room, based on the area information 115a.

The generation unit 118 decides whether the control condition relating to the child's room (for example, the control IDs “3” and “4” illustrated in FIG. 9) and the control condition not relating to the usage purpose of the target area TA (for example, the control IDs “5” to “8” illustrated in FIG. 9) are satisfied, based on the analysis information.

The analysis information includes that the person P sits while facing the illumination area of the lighting equipment LEe, and does not include being in a still pose, and hence the generation unit 118 decides that the control ID “3” is satisfied. The generation unit 118 decides that the control conditions being associated with the control IDs “4” to “8” are not satisfied.

According to the control content being associated with the control ID “3”, the generation unit 118 generates the control signal for brightening, among the lighting equipment LEe and LEg being associated with the target area TAc, the lighting equipment LEe in front of the person Pd at highest brightness. Further, the generation unit 118 generates the control signal for dimming the lighting equipment LEg behind the person Pd at brightness lower than the lighting equipment LEe. With this, studying in the child's room can be facilitated.

For example, in the target area TAd (bed room) illustrated in FIG. 12, it is assumed that the person Pb is asleep. In this case, the analysis information based on an image being acquired by photographing the target area TAd includes that one person P is asleep in the target area TAd. The generation unit 118 determines the usage purpose of the target area TAd being associated with the analysis information as the bed room, based on the area information 115a.

The generation unit 118 decides whether the control condition relating to the bed room (for example, the control ID “4” illustrated in FIG. 9) and the control condition not relating to the usage purpose of the target area TA (for example, the control IDs “5” to “8” illustrated in FIG. 9) are satisfied, based on the analysis information.

The analysis information includes that the person P lies down, and hence the generation unit 118 decides that the control ID “4” is satisfied. The generation unit 118 decides that the control conditions being associated with the control IDs “5” to “7” are not satisfied.

According to the control content being associated with the control ID “4”, the generation unit 118 generates the control signal for turning off the lighting equipment LEh being associated with the target area TAd. With this, comfortable sleep can be achieved.

The person P who is asleep may remain in a pose of lying down for five seconds or more, for example. Thus, the analysis information relating to the target area TAd may also include being a still pose. In this case, the generation unit 118 decides that the control condition being associated with the control ID “8” is satisfied. Even with this decision, the control content being associated with the control condition is dimming the lighting equipment at lowest brightness. Thus, there is no contradiction with the above-mentioned control signal, and comfortable sleep can be achieved.

Refer back to FIG. 11.

The lighting control unit 114 outputs the control signal being generated in step S121 to each of pieces of the lighting equipment LE being associated with the control signal (step S131), and then the lighting management processing is terminated.

When step S131 is executed, the lighting equipment LE acquires the control signal being associated therewith. The lighting equipment LE executes lighting-on or lighting-off according to the control signal being acquired.

By executing the lighting management processing described above, the lighting equipment LE being associated with the target area TA can be controlled in substantially real time, based on an image being acquired by photographing the target area TA. In particular, in the present example embodiment, the lighting equipment LE being associated with the target area TA can be controlled, only based on the image being acquired by photographing the target area TA.

The first example embodiment is described above.

### Advantageous Effect

According to the present example embodiment, the lighting management apparatus 101 includes the first acquisition unit 111 and the signal generation unit 112. The first acquisition unit 111 acquires analysis information based on a result being estimated by using an analysis of an image being acquired by photographing the target area TA. The analysis information includes a pose of the person P present in the target area TA. The signal generation unit 112 generates a control signal for controlling the one or plurality of pieces of lighting equipment LE being associated with the target area TA, by using the analysis information and a usage purpose of the target area TA.

With this, the one or plurality of pieces of lighting equipment LE being associated with the target area TA can be controlled by using the pose of the person P present in the target area TA being acquired from the image being acquired by photographing the target area TA and the usage purpose of the target area TA. Therefore, it is possible to provide the lighting management apparatus 101 and the like that solve a problem of improving convenience regarding lighting. Further, power consumption can be reduced, and safety can be improved.

According to the present example embodiment, a pose is indicated by using a skeleton model being acquired by modeling a skeleton of a person.

With this, the one or plurality of pieces of lighting equipment LE being associated with the target area TA can be controlled by using the pose of the person P present in the target area TA being acquired from the image being acquired by photographing the target area TA and the usage purpose of the target area TA. Therefore, it is possible to provide the lighting management apparatus 101 and the like that solve a problem of improving convenience regarding lighting. Further, power consumption can be reduced, and safety can be improved.

According to the present example embodiment, a pose includes whether to be a still pose being a same pose for a predetermined time or more.

With this, the one or plurality of pieces of lighting equipment LE being associated with the target area TA can be controlled by using the pose of the person P that includes the still pose and the usage purpose of the target area TA. Therefore, it is possible to provide the lighting management apparatus 101 and the like that solve a problem of improving convenience regarding lighting. Further, power consumption can be reduced, and safety can be improved.

According to the present example embodiment, the analysis information further includes at least one of the number of persons P present in the target area TA, orientation, and a position.

With this, by further using at least one of the number of persons P present in the target area TA, orientation, and a position that are acquired from an image being acquired by photographing a form area TA, the one or plurality of pieces of lighting equipment LE being associated with the target area TA can be controlled more appropriately. Therefore, it is possible to provide the lighting management apparatus 101 and the like that solve a problem of improving convenience regarding lighting. Further, power consumption can be reduced, and safety can be improved.

According to the present example embodiment, the lighting management apparatus 101 further includes the lighting control unit 114 that outputs a control signal to the one or plurality of pieces of lighting equipment LE.

With this, according to the control signal being generated by using a pose of the person P present in the target area TA being acquired from an image being acquired by photographing the form area TA and the usage purpose of the target area TA, the one or plurality of pieces of lighting equipment LE being associated with the target area TA can be controlled more appropriately. Therefore, it is possible to provide the lighting management apparatus 101 and the like that solve a problem of improving convenience regarding lighting. Further, power consumption can be reduced, and safety can be improved.

According to the present example embodiment, the lighting management system 100 includes the analysis apparatus 102 that analyzes an image being acquired by photographing the target area TA and generates analysis information. The first acquisition unit 111 acquires the analysis information being generated by the analysis apparatus 102.

With this, a processing load of the lighting management apparatus 101 can be reduced more as compared to a case in which the lighting management apparatus 101 executes an image analysis. Therefore, it is possible to provide the lighting management apparatus 101 and the like that solve a problem of improving convenience regarding lighting. Further, power consumption can be reduced, and safety can be improved.

For example, the first example embodiment may be modified in the following manner.

### First Modification Example

Each of the target areas TAa to TAd according to the first example embodiment is one example of the target area TA, and the target area TA is not limited thereto. For example, it is only required to provide at least one target area TA. Further, the target area TA is not limited to the living room, the dining room, the child's room, and the bed room, and for example, may be another area in a house, or may be an office, a conference room, a factory, an operation area of a factory in which an operator performs a work operation, or the like.

The lighting management system 100 is only required to include at least one photographing apparatus PE that photographs the target area TA. When the lighting management system 100 includes the plurality of photographing apparatuses PE, the number of photographing apparatuses PE may be any number equal to or greater than two. The lighting management system 100 is only required to include at least one piece of lighting equipment LE being associated with the target area TA. When the lighting management system 100 includes the plurality of pieces of lighting equipment LE, the number of pieces of lighting equipment LE may be any number equal to or greater than two. The lighting equipment LE is not limited to the lighting equipment LE being installed on a ceiling or on the desks Tc and Td, and may be lighting equipment being installed on a wall, a floor, or the like, and an installation mode thereof may be changed in a various manners.

The photographing apparatus PE may be incorporated into another piece of equipment (for example, the television TV, the lighting equipment LE, an air-conditioner omitted in illustration, or the like) installed in the target area TA.

According to the present modification example, an advantageous effect similar to that in the first example embodiment can be achieved.

### Second Modification Example

In the first example embodiment, description is made on an example in which the first acquisition unit 111 acquires analysis information from the analysis apparatus 102, but the first acquisition unit 111 may include the analysis function included in the analysis apparatus 102, generate the analysis information by the first acquisition unit 111 itself, and thereby acquire the generated analysis information. In other words, in the present modification example, description is made on an example in which the first acquisition unit 111 analyzes an image being acquired by photographing the target area TA and generates the analysis information.

In the present modification example, the lighting management system 100 may not include the analysis apparatus 102. Further, the lighting management apparatus 101 may not include the image transfer unit 113.

In the present modification example, in step S111 of the lighting management processing, the first acquisition unit 111 analyzes an image being acquired by photographing the target area TA instead of acquiring the analysis information from the analysis apparatus 102. Further, similarly to the analysis apparatus 102 according to the first example embodiment, the first acquisition unit 111 according to the present modification example generates the analysis information. As a result, the first acquisition unit 111 according to the present modification example acquires the analysis information.

According to the present modification example, an advantageous effect similar to that in the first example embodiment can also be achieved, except for the advantageous effect achieved by the analysis apparatus 102 of the lighting management system 100. According to the present modification example, it is not required to include the analysis apparatus 102, and hence the configuration of the lighting management system 100 can be simplified more as compared to the first example embodiment.

### Third Modification Example

In the present modification example, description is made on an example in which the lighting management system 100 further includes a control terminal that acquires a control signal from the lighting management apparatus 101 and outputs the control signal being acquired to one or each of a plurality of pieces of lighting equipment LE.

The lighting management system 100 may further include a control terminal that transfers the control signal and image information.

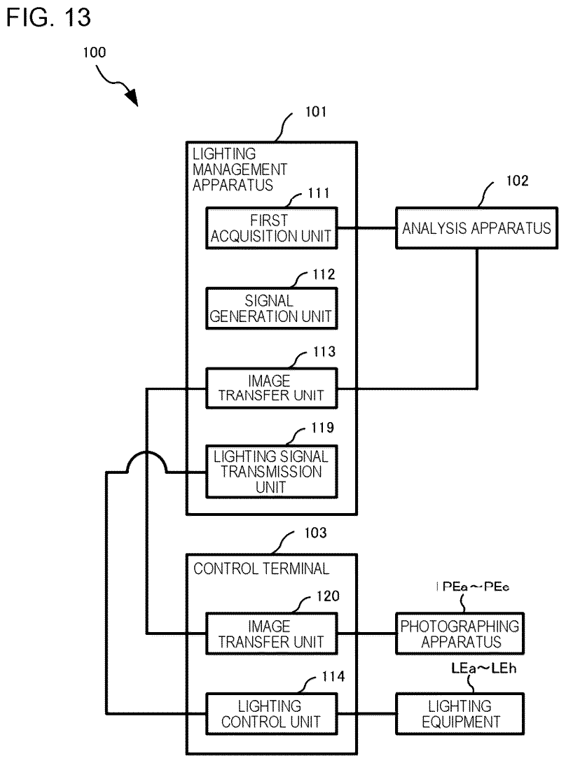

FIG. 13 is a diagram illustrating a configuration example of the lighting management system 100 according to a third modification example. The lighting management system 100 includes a control terminal 103, in addition to the photographing apparatuses PEa to PEe, the lighting equipment LEa to LEh, the lighting management apparatus 101, and the analysis apparatus 102.

The control terminal 103 and the lighting management apparatus 101 are connected to each other via a communication network being wired, wireless, or a combination thereof (for example, a local area network (LAN)), and transmit and receive information mutually via the communication network.

The control terminal 103 includes an image transfer unit 120 and the lighting control unit 114 in a functional sense.

The image transfer unit 120 acquires image information being generated by the photographing apparatus PE from the photographing apparatus PE, and transfers the image information being acquired to the analysis apparatus 102.

Similarly to the first example embodiment, the lighting control unit 114 outputs the control signal being generated by the signal generation unit 112 to the one or plurality of pieces of lighting equipment LE. Specifically, the lighting control unit 114 acquires the control signal being generated by the signal generation unit 112 from the lighting management apparatus 101, and outputs the control signal being acquired to the one or plurality of pieces of lighting equipment LE.

The lighting management apparatus 101 according to the present modification example further includes a lighting signal transmission unit 119. The lighting signal transmission unit 119 transmits the control signal being generated by the signal generation unit 112 to the control terminal 103.

The control terminal 103 may be configured similarly to the lighting management apparatus 101 according to the first example embodiment in a physical sense.

In the lighting management processing according to the present modification example, the image transfer unit 120 acquires the image information being generated by the photographing apparatus PE from the photographing apparatus PE, and transfers the image information being acquired from the photographing apparatus PE to the analysis apparatus 102. In step S101 (see FIG. 11), the image transfer unit 113 acquires the image information being generated by the photographing apparatus PE from the control terminal 103, and transfers the image information being acquired to the analysis apparatus 102.

The lighting management apparatus 101 executes steps S111 and S112 similar to those in the first example embodiment.

In step S131, the lighting signal transmission unit 119 outputs the control signal being generated by the signal generation unit 112 to the control terminal 103. The lighting control unit 114 according to the present modification example acquires the control signal from the lighting management apparatus 101, and outputs the control signal to each of pieces of the lighting equipment LE being associated with the control signal. With this, the lighting equipment LE acquires the control signal being associated therewith, and is lighting-on or lighting-off according to the control signal being acquired.

According to the present modification example, an advantageous effect similar to that in the first example embodiment can also be achieved. Note that, the first acquisition unit 111 similar to that in the second modification example may also be applied to the lighting management apparatus 101 according to the present modification example. With this, an advantageous effect similar to that in the second modification example can be achieved.

### Second Example Embodiment

In the first example embodiment, description is made on an example in which analysis information includes at least one of a pose of a person P, and the number of persons P present in a target area TA, orientation, and a position. The analysis information may further include at least one of a movement of the person P present in the target area TA and a surrounding situation of the person P (a situation within a predetermined range).

In the present example embodiment, a different point from the first example embodiment is mainly described for the sake of clarity of the description, and overlapping description is omitted as appropriate.

A lighting management system according to the present example embodiment is configured substantially similarly to the lighting management system 100 according to the first example embodiment.

As described above, the analysis information according to the present example embodiment may further include at least one of a movement of the person P present in the target area TA and a surrounding situation of the person P (the situation within the predetermined range). The surrounding situation of the person P is a situation within a predetermined range from the person P.

Examples of the movement of the person P include, for example, a moving action, a dining action (for example, an action of lifting and lowering chopsticks, or reaching for a dish with chopsticks), a writing action, an operation of a terminal (for example, a tablet terminal, or a mobile terminal), an action of flipping a page of a book, and the like.

Examples of the surrounding situation of the person P include, for example, a type of an item (for example, a dish, a document, a book, a notebook, a tablet terminal, a mobile terminal, a television) present within the predetermined range from the person P, an operation state of the item (for example, whether a tablet terminal, a mobile terminal, a television, or the like is in operation), and the like.

An analysis apparatus 102 is capable of acquiring the movement of the person P present in the target area TA and the surrounding situation of the person P (the situation within the predetermined range) by using an analysis function described in the first example embodiment. Thus, the analysis apparatus 102 analyzes an image included in image information being acquired from a lighting management apparatus 101, and generates the analysis information including at least one of the movement of the person P present in the target area TA and the surrounding situation of the person P (the situation within the predetermined range).

A pattern storage unit 117 according to the present example embodiment (see FIG. 6) stores control pattern information 117b in place of the control pattern information 117a according to the first example embodiment.

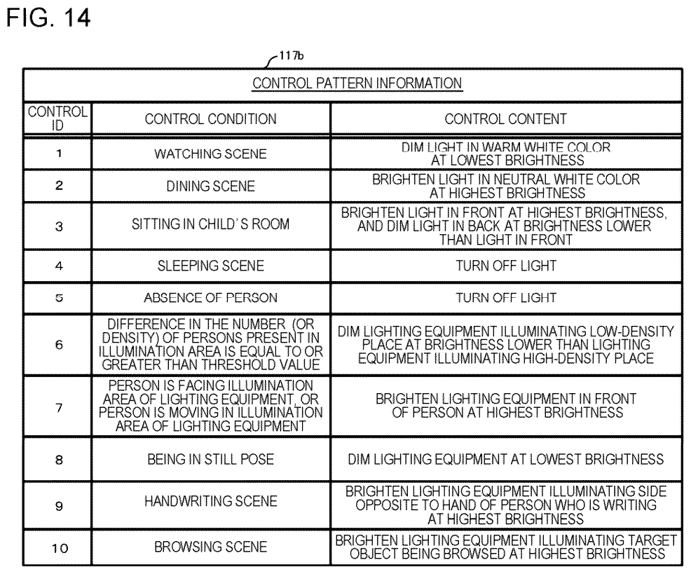

FIG. 14 is a diagram illustrating one example of the control pattern information 117b according to the present example embodiment. Similarly to the control pattern information 117a according to the first example embodiment, the control pattern information 117b is information in which a control ID, a control condition, and a control content are associated with one another. The control condition according to the present example embodiment may include a usage scene.

The usage scene is a situation where the person P uses the target area TA. Specifically, examples of the usage scene include a watching scene, a handwriting scene, a browsing scene, a dining scene, a sleeping scene, and the like

The watching scene is a situation involving watching television. The handwriting scene is a situation where the person P is engaged in handwriting. The browsing scene is a situation involving browsing of a target object such as a book, a document, a tablet terminal, and a mobile terminal. The dining scene is a situation involving dining. The sleeping scene is a situation involving sleeping.

Specifically, for example, there is given an example in which, in the control pattern information 117b illustrated in FIG. 14, the control condition including the usage scene is associated with the control IDs “1”, “2”, “4”, “9”, and “10”.

For example, each of control patterns of the control IDs “1”, “2”, and “4” according to the present example embodiment is an example of the usage scene relating to a usage purpose of the target area TA.

Specifically, the “watching scene” is associated with a living room. The “watching scene” is associated with a control content for watching television comfortably in the living room. The “dining scene” is associated with a dining room. The “dining scene” is associated with a control content for enjoying a meal comfortably. The “sleeping scene” is associated with a child's room or a bed room. The “sleeping scene” is associated with a control content for achieving comfortable sleep.

For example, each of the control patterns of the control IDs “9” and “10” according to the present example embodiment is an example of the usage scene not relating to the usage purpose of the target area TA.

The “handwriting scene” is associated with a control content for comfortably writing. The “browsing scene” is associated with a control content for comfortably browsing a target object such as a book, a document, a tablet terminal, and a mobile terminal.

In addition to a function similar to that in the first example embodiment, a generation unit 118 according to the present example embodiment (see FIG. 6) estimates the usage scene by using the analysis information, and generates a control signal by using the usage scene being estimated.

Specifically, the generation unit 118 estimates the usage scene, based on the analysis information. Alternatively, the generation unit 118 estimates the usage scene, based on the analysis information and area information 115a. Further, the generation unit 118 generates a control signal, based on the usage scene being estimated, the analysis information, lighting information 116a, and the control pattern information 117b.

For example, the generation unit 118 estimates the watching scene, based on a part or an entirety of the usage purpose of the target area TA being the living room, a pose of the person P, and a surrounding situation of the person P where a television screen is on. For example, the generation unit 118 estimates the handwriting scene, based on a movement of the person P. For example, the generation unit 118 estimates the browsing scene, based on a part or an entirety of the surrounding situation of the person P where a book, a notebook, a tablet terminal, or a mobile terminal is present, and an action or an operation relating thereto.

For example, the generation unit 118 estimates the dining scene, based on a part or an entirety of the usage purpose of the target area TA being the dining room, at least one of the movement and the pose of the person P, and the surrounding situation of the person P where the dish D is present. For example, the generation unit 118 estimates the sleeping scene, based on a part or an entirety of the usage purpose of the target area TA being the child's room or the bed room, and the pose in which the person P is asleep.

When there is a control condition including the usage scene being estimated, the generation unit 118 decides that the control condition is satisfied. When the control condition is satisfied, the generation unit 118 generates the control signal for controlling a piece of lighting equipment LE being identified by using a lighting ID associated with the target area TA (area ID), based on the control content being associated with the control condition and the lighting information 116a.

### Lighting Management Processing according to Second Example Embodiment

In lighting management processing according to the present example embodiment, details of step S121 are different from the first example embodiment. Except for this point, the lighting management processing may be similar to that of the first example embodiment.

In step S121 according to the present example embodiment, as described above, the generation unit 118 estimates the usage scene, and generates a control signal by using the usage scene being estimated.

For example, in a target area TAa (living room) illustrated in FIG. 12, it is assumed that persons Pa and Pc sit on a sofa S and watch television. In this case, the analysis information based on an image being acquired by photographing the target area TAa includes that two persons P sit on the sofa S in the target area TAa, a television TV is in front of the persons P, and the television TV is in operation. The generation unit 118 determines the usage purpose of the target area TAa being associated with the analysis information as the living room, based on the area information 115a.

The generation unit 118 estimates as the watching scene, based on the analysis information relating to the target area TAa and the usage purpose. The generation unit 118 decides that the control condition being associated with the control ID “1” is satisfied. According to the control content being associated with the control ID “1”, the generation unit 118 turns on lighting equipment LEa and LEb being associated with the target area TAa in a warm white color at lowest brightness (for example, brightness “1”).

Further, similarly to the first example embodiment, according to the control content being associated with the control ID “6”, the generation unit 118 dims the lighting equipment LEb illuminating a low-density place at brightness lower than the lighting equipment LEa illuminating a high-density place.

As a result, similarly to an example described with reference to FIG. 12 in the first example embodiment, according to the control contents being associated with the control IDs “1” and “6”, the generation unit 118 generates the control signal for turning on the lighting equipment LEa in the warm white color at brightness “1”. In addition to this, the generation unit 118 generates the control signal for turning off the lighting equipment LEb in order to dim the lighting equipment LEb at brightness lower than brightness “1”. With this, power consumption can be reduced while the person P in the living room is relaxed.

For example, in a target area TAc (child's room) illustrated in FIG. 12, it is assumed that a person Pd is facing a desk Tc, sitting on a chair C, and studying. The analysis information based on an image being acquired by photographing the target area TAc includes one person P sitting in the target area TAc, a writing action, an action of flipping a page of a document or the like, and presence of a book, a notebook, or the like in a periphery of the person P. The generation unit 118 determines the usage purpose of the target area TAc being associated with the analysis information as the child's room, based on the area information 115a.

The generation unit 118 estimates the handwriting scene and the browsing scene, based on the analysis information relating to the target area TAc and the usage purpose. The generation unit 118 decides that the control conditions being associated with the control IDs “9” and “10” are satisfied. Further, similarly to the first example embodiment, the generation unit 118 decides that the control condition being associated with the control ID “3” is satisfied.

According to the control contents being associated with the control IDs “3”, “9”, and “10”, the generation unit 118 controls lighting equipment LEe and LEg being associated with the target area TAc. In a case of the lighting equipment LEe in front of the person Pd, when the person Pd writes with a right hand, by turning on the lighting equipment LEe, the lighting equipment LE illuminating a side opposite to a hand of a person who is writing can be brightened at highest brightness. Further, by turning on the lighting equipment LEe, the lighting equipment LE illuminating a target object being browsed can be brightened at highest brightness.

As a result, similarly to an example described with reference to FIG. 12 in the first example embodiment, the generation unit 118 according to the present example embodiment generates the control signal for brightening the lighting equipment LEe in front of the person Pd at highest brightness. Further, the generation unit 118 generates the control signal for dimming the lighting equipment LEg behind the person Pd at brightness lower than the lighting equipment LEe. With this, studying in the child's room can be facilitated. Further, writing or browsing can be performed comfortably.

The second example embodiment is described above.

### Advantageous Effect

According to the present example embodiment, analysis information further includes at least one of a movement of the person P present in the target area TA and a surrounding situation of the person P. A signal generation unit 112 (the generation unit 118) estimates a usage scene being a situation where the person P uses the target area TA, by using the analysis information, and generates a control signal by using the usage scene being estimated.

With this, based on at least one of the movement of the person P and the surrounding situation of the person P, one or plurality of pieces of the lighting equipment LE being associated with the target area TA can be controlled more appropriately. Therefore, it is possible to provide the lighting management apparatus 101 and the like that solve a problem of improving convenience regarding lighting. Further, power consumption can be reduced, and safety can be improved.

According to the present example embodiment, the signal generation unit 112 (the generation unit 118) generates a control signal by using a current usage scene.

With this, based on the current usage scene, the one or plurality of pieces of lighting equipment LE being associated with the target area TA can be controlled as appropriate. Therefore, it is possible to provide the lighting management apparatus 101 and the like that solve a problem of improving convenience regarding lighting. Further, power consumption can be reduced, and safety can be improved.

### Fourth Modification Example

In the second example embodiment, description is made on an example in which a control signal is generated by using a current usage scene. However, the above-mentioned control pattern information 117b is one example of a control pattern using a usage scene, and may be changed as appropriate. For example, the control signal may be generated by using an elapsed time from start of the usage scene.

Specifically, for example, in the control pattern relating to the sleeping scene, the control condition may include that an elapsed time from estimation of the sleeping scene exceeds a predetermined time (for example, 30 minutes). For example, in the control condition, “lighting-off” may be associated with the control content. With this, lighting-off cannot be forgotten after going to bed, and comfortable sleep can be achieved.

Further, for example, in the control pattern relating to the handwriting scene or the browsing scene, the control condition may include that a predetermined time (for example, 60 minutes) is elapsed from estimation of the handwriting scene or the browsing scene. For example, in the control condition, flashing or dimming of the lighting equipment LE illuminating a side opposite to a hand of the person P who is writing or the lighting equipment LE illuminating a target object being browsed may be associated. With this, an appropriate break time can be notified, and comfortability for the person P who is engaged in writing or browsing can be improved.

According to the present modification example, the signal generation unit 112 (the generation unit 118) generates a control signal by using an elapsed time from start of a usage scene.

With this, based on the elapsed time from the start of the usage scene, the one or plurality of pieces of lighting equipment LE being associated with the target area TA can be controlled as appropriate. Therefore, it is possible to provide the lighting management apparatus 101 and the like that solve a problem of improving convenience regarding lighting. Further, power consumption can be reduced, and safety can be improved.

### Fifth Modification Example

A control condition may include a time being set as appropriate, such as seven o'clock in the morning. In the control condition, a control content being set as appropriate may be associated, and a control condition that lighting equipment LEh in a target area TAd (bed room) is turned on in a neutral white color at highest brightness may be associated, for example. With this, it is possible to wake up reliably and comfortably.

### Third Example Embodiment

In the present example embodiment, description is made on an example in which control pattern information includes a control pattern for each person. With this, a piece of lighting equipment LE can be controlled according to a preference of each of persons P. In the present example embodiment, a different point from the first example embodiment is mainly described for the sake of clarity of the description, and overlapping description is omitted as appropriate.

A lighting management system according to the present example embodiment is configured substantially similarly to the lighting management system 100 according to the first example embodiment.

Analysis information according to the present example embodiment includes individual identification information for identifying the person P present in a target area TA being estimated by using an analysis of an image being acquired by photographing the target area TA. For example, the individual identification information is a face feature value. The face feature value may be converted based on a table or the like being decided in advance.

A pattern storage unit 117 according to the present example embodiment (see FIG. 6) stores control pattern information 117c in advance in place of the control pattern information 117a according to the first example embodiment.

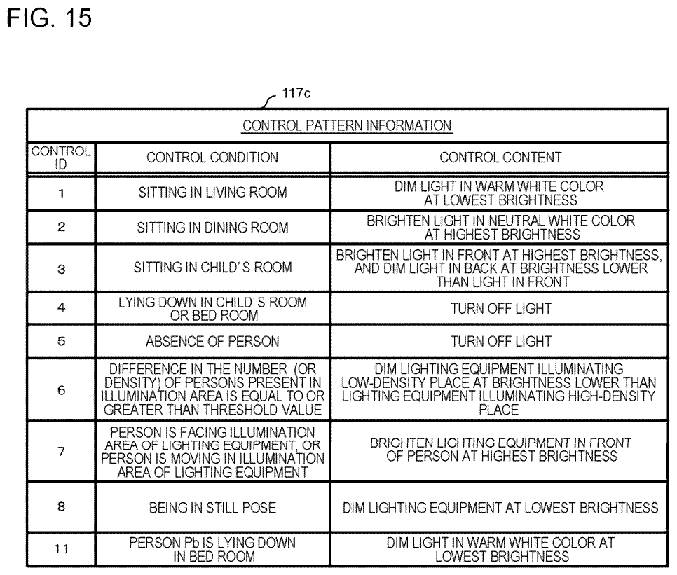

FIG. 15 is a diagram illustrating one example of the control pattern information 117c according to the present example embodiment. Similarly to the control pattern information 117a according to the first example embodiment, the control pattern information 117c is information in which a control ID, a control condition, and a control content are associated with one another. The control pattern information 117c according to the present example embodiment includes a control pattern being associated with a control ID “11”.
the control pattern being associated with the control ID “11” decides a control pattern being associated with a person Pb being identified by using individual identification information relating to the “person Pb”. In other words, the control pattern being associated with the control ID “11” is an example of an individual control pattern in which a control pattern is decided according to the individual identification information.

Specifically, similarly to the first example embodiment, a generation unit 118 generates a control signal for controlling one or plurality of pieces of lighting equipment LE being associated with the target area TA, by using the analysis information being acquired by a first acquisition unit 111 and a usage purpose of the target area TA.

When the individual control pattern and other control patterns contradict with each other, the generation unit 118 prioritizes the individual control pattern.

For example, description is made on an example in which a control signal for turning off a piece of lighting equipment LEh is generated in step S121 according to the first example embodiment (see FIG. 11) because the person Pb is asleep in a target area TAd (bed room).

When the generation unit 118 executes processing similar to that in the first example embodiment, based on the analysis information relating to the target area TAd and the like, the generation unit 118 decides that the control IDs “4” and “11” are satisfied. Those control conditions contradict with each other, and hence the individual control pattern of the control ID “11” is prioritized.

According to a control content being associated with the control ID “11”, the generation unit 118 generates a control signal for turning on the lighting equipment LEh being associated with the target area TAd in a warm white color at lowest brightness. With this, the person Pb can sleep with brightness according to an own preference of the person Pb, and hence comfortable sleep can further be achieved.

According to the present example embodiment, analysis information further includes individual identification information for identifying the person P present in the target area TA being estimated by using an analysis of an image being acquired by photographing the target area TA. A signal generation unit 112 (the generation unit 118) generates the control signal by using an individual control pattern in which a control pattern is decided according to the individual identification information.

With this, according to a preference of the person P, the one or plurality of pieces of lighting equipment LE can be controlled. Therefore, it is possible to provide the lighting management apparatus 101 and the like that solve a problem of improving convenience regarding lighting. Further, power consumption can be reduced, and safety can be improved.

### Fourth Example Embodiment

In the present example embodiment, description is made on an example in which an action of a person P in a target area TA is predicated based on analysis information, and a piece of lighting equipment LE is controlled based on a prediction result.

In the present example embodiment, a different point from the first example embodiment is mainly described for the sake of clarity of the description, and overlapping description is omitted as appropriate.

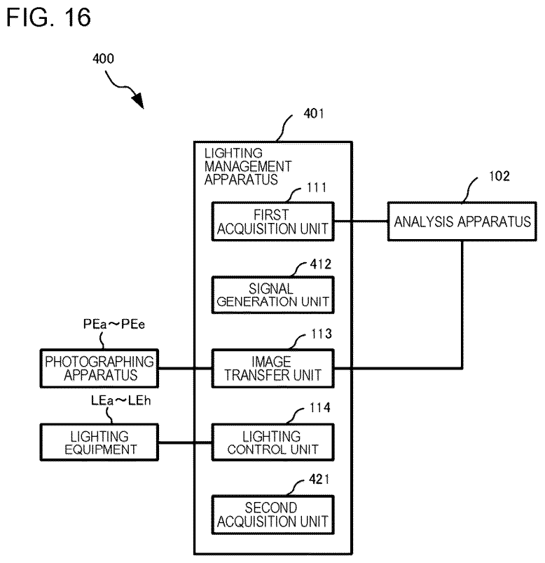

FIG. 16 is a diagram illustrating a configuration example of a lighting management system 400 according to the present example embodiment. The lighting management system 400 according to the present example embodiment includes a lighting management apparatus 401 in place of the lighting management apparatus 101 according to the first example embodiment. Except for this point, the lighting management system 400 may be configured similarly to the lighting management system 100 according to the first example embodiment.

The lighting management apparatus 401 includes a signal generation unit 412 in place of the signal generation unit 112 according to the first example embodiment. Further, the lighting management apparatus 401 includes a second acquisition unit 421. Except for those points, the lighting management apparatus 401 may be configured similarly to the lighting management apparatus 101 according to the first example embodiment.

For example, the second acquisition unit 421 acquires analysis information from a first acquisition unit 111. The second acquisition unit 421 may acquire the analysis information from an analysis apparatus 102. In this case, the second acquisition unit 421 may store the analysis information being acquired.

The second acquisition unit 421 executes statistic processing for the analysis information. The second acquisition unit 421 predicts an action of the person P present in the target area, based on a result of the statistic processing for the analysis information. The second acquisition unit 421 generates prediction information including a prediction result.

In addition to a function similar to that in the first example embodiment, the signal generation unit 412 generates a control signal for controlling one or plurality of pieces of the lighting equipment LE being associated with the target area TA by using a result being predicted by the second acquisition unit 421.

### (Operation of Lighting Management System 400)

The lighting management system 400 according to the present example embodiment executes lighting management processing. The lighting management processing according to the present example embodiment executes prediction control processing in addition to the lighting management processing similar to that in the first example embodiment. The prediction control processing is processing for controlling the lighting equipment LE, based on a result being acquired by predicting an action of the person P present in the target area TA.

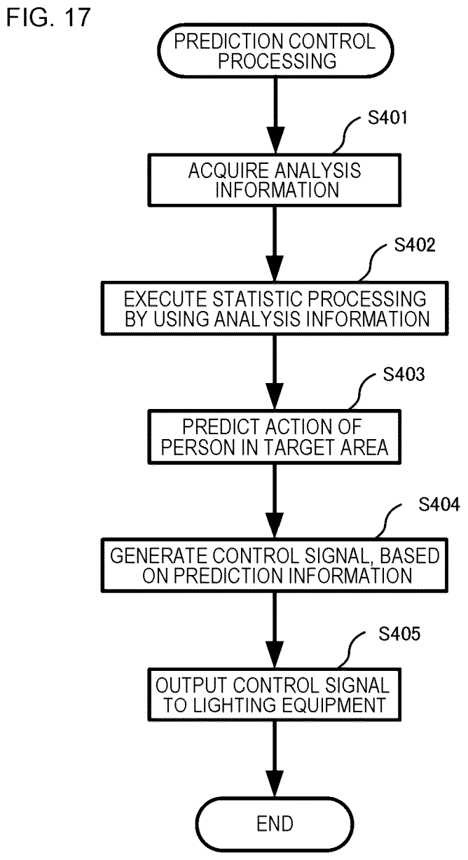

FIG. 17 is a flowchart illustrating one example of the prediction control processing according to the present example embodiment. For example, during its operation, the lighting management apparatus 401 executes the prediction control processing in a repeated manner.

The second acquisition unit 421 acquires analysis information (step SS401). Herein, the second acquisition unit 421 acquires not only the current analysis information but also the analysis information in past.

The second acquisition unit 421 executes the statistic processing by using the analysis information being acquired in step SS401 (step SS402).

For example, the second acquisition unit 421 executes the statistic processing for a pose of the person P in each of the target areas TA by time period.

The second acquisition unit 421 predicts an action of the person P in the target area TA, based on a result of the statistic processing being executed in step SS402 (step S403).

For example, it is assumed that the second acquisition unit 421 executes the statistic processing for the analysis information, and thereby acquires a result indicating that the person P often sits in a target area TAb (dining room) at seven o'clock in the afternoon. In this case, the second acquisition unit 421 predicts that the person P sits in the dining room at seven o'clock in the afternoon. The second acquisition unit 421 generates the prediction information including a prediction result.

Further, for example, it is assumed that the second acquisition unit 421 executes the statistic processing for the analysis information, and thereby acquires a result indicating that the person P is often absent in the target area TAb (dining room) at ten o'clock at night. In this case, the second acquisition unit 421 predicts that the person P is absent in the dining room at ten o'clock at night. The second acquisition unit 421 generates the prediction information including the prediction result.

The second acquisition unit 421 generates a control signal, based on the prediction information being generated in step S403 (step S404).

For example, the second acquisition unit 421 refers to control pattern information 117a, and determines a control pattern (a control pattern of a control ID “2”) including, in a control condition, sitting of the person P in the dining room. According to a control content included in the control pattern being determined and lighting information 116a, the second acquisition unit 421 generates a control signal for brightening lighting equipment LEa and LEb, which are identified by using lighting IDs LEa and LEb being associated with the target area TAb, in a neutral white color at highest brightness at seven o'clock in the afternoon.

For example, the second acquisition unit 421 refers to the control pattern information 117a, and determines a control pattern (a control pattern of the control ID “5”) including, in the control condition, absence of the person P in the dining room. According to the control content included in the control pattern being determined and the lighting information 116a, the second acquisition unit 421 generates a control signal for turning off the lighting equipment LEa and LEb, which are identified by using the lighting IDs LEa and LEb being associated with the target area TAb, at ten o'clock at night.

A lighting control unit 114 outputs the control signal being generated in step S404 to each of pieces of the lighting equipment LE being associated with the control signal (step S405), and then the lighting management processing is terminated.

When step S405 is executed, the lighting equipment LE acquires the control signal being associated therewith. the lighting equipment LE executes lighting-on or lighting-off according to the control signal being acquired.

By executing the lighting management processing described above, an action of the person P present in the target area TA can be predicted, and the lighting equipment LE being associated with the target area TA can be controlled.

The fourth example embodiment is described above.

### Advantageous Effect

According to the present example embodiment, the lighting management apparatus 401 further includes the second acquisition unit 421 that predicts an action of the person P present in the target area TA, based on a result of statistic processing for analysis information. The signal generation unit 412 further generates a control signal by using a result being predicted by the second acquisition unit 421.

With this, an action of the person P present in the target area TA can be predicted, and thus the lighting equipment LE being associated with the target area TA can be controlled. Therefore, it is possible to provide the lighting management apparatus 101 and the like that solve a problem of improving convenience regarding lighting. Further, power consumption can be reduced.

While the example embodiments and the modification examples of the present invention have been described with reference to the drawings, those are merely exemplification of the present invention, and various configurations other than those described above can also be employed.

Further, in the plurality of flowcharts used in the description given above, a plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments and the modification examples described above may be combined with each other within a range where the contents do not conflict with each other.

The whole or a part of the example embodiments described above can be described as, but not limited to, the following supplementary notes.

1. A lighting management apparatus including:
a first acquisition unit that acquires analysis information based on a result being estimated by using an analysis of an image being acquired by photographing a target area; and
a signal generation unit that generates a control signal for controlling one or a plurality of pieces of lighting equipment being associated with the target area, by using the analysis information and a usage purpose of the target area, wherein
the analysis information includes a pose of a person present in the target area.

2. The lighting management apparatus according to supplementary note 1, wherein
the pose is indicated by using a skeleton model being acquired by modeling a skeleton of the person.

3. The lighting management apparatus according to supplementary note 1 or 2, wherein
the pose includes whether to be a still pose being a same pose for a predetermined time or more.

4. The lighting management apparatus according to any one of supplementary notes 1 to 3, wherein
the analysis information further includes at least one of a movement of a person present in the target area and a surrounding situation of the person, and
the signal generation unit further estimates a usage scene being a situation of the person using the target area, by using the analysis information, and generates the control signal by using the usage scene being estimated.

5. The lighting management apparatus according to supplementary note 4, wherein
the signal generation unit generates the control signal by using at least one of a current usage scene and an elapsed time from start of the usage scene.

6. The lighting management apparatus according to any one of supplementary notes 1 to 5, wherein
the analysis information further includes at least one of a number of persons present in the target area, orientation, and a position.

7. The lighting management apparatus according to any one of supplementary notes 1 to 6, further including
a second acquisition unit that predicts an action of a person present in the target area, based on a result of statistic processing for the analysis information, wherein
the signal generation unit further generates the control signal by using a result being predicted by the second acquisition unit.

8. The lighting management apparatus according to any one of supplementary notes 1 to 7, wherein
the analysis information further includes individual identification information for identifying a person in the target area, the person being estimated by using an analysis of an image being acquired by photographing the target area, and
the signal generation unit further generates the control signal by using an individual control pattern being acquired by deciding a control pattern associated with the individual identification information.

9. The lighting management apparatus according to any one of supplementary notes 1 to 8, further including
a lighting control unit that outputs the control signal to the one or plurality of pieces of lighting equipment.

10. The lighting management apparatus according to any one of supplementary notes 1 to 9, wherein
the first acquisition unit analyzes an image being acquired by photographing the target area, and generates the analysis information.

11. A lighting management system including:
the lighting management apparatus according to any one of supplementary notes 1 to 8;
one or a plurality of photographing apparatuses that generate image information including the image being acquired by photographing the target area; and
the one or plurality of pieces of lighting equipment being associated with the target area.

12. The lighting management system according to supplementary note 11, further including
an analysis apparatus that analyzes an image being acquired by photographing the target area and generates the analysis information, wherein
the first acquisition unit acquires the analysis information being generated by the analysis apparatus.

13. The lighting management system according to supplementary note 11, wherein
the first acquisition unit analyzes an image being acquired by photographing the target area, and generates the analysis information.

14. The lighting management system according to any one of supplementary notes 11 to 13, wherein
The lighting management apparatus further includes a lighting control unit that outputs the control signal to each of the one or plurality of pieces of lighting equipment.

15. The lighting management system according to any one of supplementary notes 11 to 13, further including
a control terminal that acquires the control signal from the lighting management apparatus, and outputs the control signal being acquired to each of the one or plurality of pieces of lighting equipment.

16. A lighting management method including,
by a computer:
   acquiring analysis information based on a result being estimated by using an analysis of an image being acquired by photographing a target area; and
   generating a control signal for controlling one or a plurality of pieces of lighting equipment being associated with the target area, by using the analysis information and a usage purpose of the target area, wherein
the analysis information includes a pose of a person present in a target area.

17. A storage medium storing a program for causing a computer to execute:
acquiring analysis information based on a result being estimated by using an analysis of an image being acquired by photographing a target area; and
generating a control signal for controlling one or a plurality of pieces of lighting equipment being associated with the target area, by using the analysis information and a usage purpose of the target area, wherein
the analysis information includes a pose of a person present in the target area.

18. A program for causing a computer to execute:
acquiring analysis information based on a result being estimated by using an analysis of an image being acquired by photographing a target area; and
generating a control signal for controlling one or a plurality of pieces of lighting equipment being associated with the target area, by using the analysis information and a usage purpose of the target area, wherein
the analysis information includes a pose of a person present in the target area.

### REFERENCE SIGNS LIST

100, 400 Lighting management system
101, 401 Lighting management apparatus
102 Analysis apparatus
103 Control terminal
111 First acquisition unit
112, 412 Signal generation unit
113 Image transfer unit
114 Lighting control unit
115 Area storage unit
115a Area information
116 Lighting storage unit
116a Lighting information
117 Pattern storage unit
117a to 117c Control pattern information
118 Generation unit
119 Lighting signal transmission unit
120 Image transfer unit
421 Second acquisition unit
LE, LEa to LEh Lighting equipment
P, Pa to Pd Person
PE, PEa to PEe Photographing apparatus
TA, TAa to TAd Target area

What is claimed is:

1. A lighting management apparatus comprising:
at least one memory configured to store instructions; and
at least one processor configured to execute the instructions to perform operations comprising:
acquiring analysis information based on a result being estimated by using an analysis of an image being acquired by photographing a target area; and
generating a control signal for controlling one or a plurality of pieces of lighting equipment being associated with the target area, by using the analysis information and a usage purpose of the target area, wherein
the analysis information includes a pose of a person present in the target area.

2. The lighting management apparatus according to claim 1, wherein
the pose is indicated by using a skeleton model being acquired by modeling a skeleton of the person.

3. The lighting management apparatus according to claim 1, wherein
the pose includes whether to be a still pose being a same pose for a predetermined time or more.

4. The lighting management apparatus according to claim 1, the instructions to perform operations further comprising
estimating a usage scene being a situation of the person using the target area, by using the analysis information, and
generating the control signal by using the usage scene being estimated, wherein
the analysis information further includes at least one of a movement of a person present in the target area and a surrounding situation of the person.

5. The lighting management apparatus according to claim 4, wherein
the control signal is generated by using at least one of a current usage scene and an elapsed time from start of the usage scene.

6. The lighting management apparatus according to claim 1, wherein
the analysis information further includes at least one of a number of persons present in the target area, orientation, and a position.

7. The lighting management apparatus according to claim 1, the instructions to perform operations further comprising
predicting an action of a person present in the target area, based on a result of statistic processing for the analysis information, wherein
the control signal is further generated by using a result being predicted by the second acquisition unit.

8. The lighting management apparatus according to claim 1, wherein
the analysis information further includes individual identification information for identifying a person in the target area, the person being estimated by using an analysis of an image being acquired by photographing the target area, and
the control signal is further generated by using an individual control pattern being acquired by deciding a control pattern associated with the individual identification information.

9. The lighting management apparatus according to claim 1, the instructions to perform operations further comprising
outputting the control signal to the one or plurality of pieces of lighting equipment.

10. The lighting management apparatus according to claim 1, the instructions to perform operations further comprising
analyzing an image being acquired by photographing the target area for generating the analysis information.

11. A lighting management system comprising:
the lighting management apparatus according to claim 1;
one or a plurality of photographing apparatuses that generate image information including the image being acquired by photographing the target area; and
the one or plurality of pieces of lighting equipment being associated with the target area.

12. The lighting management system according to claim 11, further comprising
an analysis apparatus that analyzes an image being acquired by photographing the target area and generates the analysis information, wherein
the lighting management apparatus acquires the analysis information being generated by the analysis apparatus.

13. The lighting management system according to claim 11, wherein
the lighting management apparatus analyzes an image being acquired by photographing the target area for generating the analysis information.

14. The lighting management system according to claim 11, wherein
The lighting management apparatus further outputs the control signal to each of the one or plurality of pieces of lighting equipment.

15. The lighting management system according to claim 11, further comprising
a control terminal that acquires the control signal from the lighting management apparatus, and outputs the control signal being acquired to each of the one or plurality of pieces of lighting equipment.

16. A lighting management method comprising,
by a computer:
acquiring analysis information based on a result being estimated by using an analysis of an image being acquired by photographing a target area; and
generating a control signal for controlling one or a plurality of pieces of lighting equipment being associated with the target area, by using the analysis information and a usage purpose of the target area, wherein
the analysis information includes a pose of a person present in a target area.

17. A non-transitory computer readable storage medium storing a program for causing a computer to execute:
acquiring analysis information based on a result being estimated by using an analysis of an image being acquired by photographing a target area; and
generating a control signal for controlling one or a plurality of pieces of lighting equipment being associated with the target area, by using the analysis information and a usage purpose of the target area, wherein
the analysis information includes a pose of a person present in the target area.
